(19) United States
(12) Patent Application Publication
(10) Pub. No.: US 2026/0319168 A1
(43) Pub. Date: Oct. 15, 2026

(54) OPTICAL PACKAGE MODULE AND PHOTONIC CHIP AND MANUFACTURING METHOD THEREOF

(71) Applicant: SILICONWARE PRECISION INDUSTRIES CO., LTD., Taichung City (TW)

(72) Inventors: Ssu-Min LIN, Taichung City (TW); Rung-Jeng LIN, Taichung City (TW)

(73) Assignee: SILICONWARE PRECISION INDUSTRIES CO., LTD., Taichung City (TW)

(21) Appl. No.: 19/400,210

(22) Filed: Nov. 25, 2025

(30) Foreign Application Priority Data
Apr. 10, 2025 (TW) 114113593

(51) Int. Cl. G02B 6/12; G02B 6/13

(52) U.S. Cl. CPC G02B 6/12002; G02B 6/13

(57) ABSTRACT

An optical package module and a photonic chip and a manufacturing method thereof are provided. The optical package module includes a support structure, a photonic chip disposed on the support structure, and a filling layer filled between the support structure and the photonic chip. The photon chip includes a chip body and a plurality of stoppers formed on opposite sides of the chip body, and thus an overflow distance of the filling layer can be shorten by the plurality of stoppers.

### BACKGROUND

### 1. Technical Field

The present disclosure relates to a semiconductor package structure and a manufacturing method thereof, and more particularly, to an optical package module and a photonic chip and a manufacturing method thereof.

### 2. Description of Related Art

With the vigorous development of the electronics industry, electronic products are gradually moving towards multi-functionality and high performance. The application of the current fifth generation (5G) communication technology has expanded to various fields such as the internet of things (IoT), industrial internet of things (IIoT), cloud, artificial intelligence (AI), autonomous car and medical. As the application level expands, a large amount of data is generated that needs to be efficiently transmitted, calculated, and stored. In particular, the demand for data transmission has emerged in large quantities, causing the industry to begin to use “light” instead of “electricity” as the carrier of data transmission, so as to increase the transmission capacity, efficiency or distance, and reduce energy consumption during the transmission process. Under this background, co-package optic devices have become the development trend of future semiconductor and packaging technologies.

Please refer to FIG. 1A, which is a cross-sectional view of a conventional co-package optic device 1. The co-package optic device 1 mainly has an optical engine 11 disposed on a circuit board 10. The optical engine 11 includes an electronic chip 112 formed in a package structure 111 and a photonic chip 113 mounted onto the package structure 111. One side end of the photonic chip 113 is connected to an optical fiber 14, and a shelf 15 is provided below the junction of the photonic chip 113 and the optical fiber 14 to transmit the optical signal to the optical engine 11 for communication. At the same time, the circuit board 10 needs to be equipped with a switch chip 12 before the circuit board 10 can be used in a terminal product, wherein the switch chip 12 is firstly disposed on a substrate 13 and then connected to the circuit board 10 via the substrate 13.

However, when the photonic chip 113 in the above-mentioned co-package optic device is mounted to the package structure 111, a gap between the photonic chip 113 and the package structure 111 is required to be filled with an underfill 114 to protect electrical contacts. As shown in the partial bottom view of FIG. 1B, the underfill 114 slightly overflows an edge of the package structure 111 and extends to the surface of the photonic chip 113. Since the bottom structure of the photonic chip 113 has grooves on both sides of the middle area (formed by the wafer process and cutting), the underfill 114 cannot continue to extend forward in the middle area of the chip due to the limitation of the edge of the package structure. Since the bottom structure of the photonic chip 113 has grooves on both sides, the underfill 114 will continue to extend forward along the grooves, causing the waveguide region in front of the photonic chip 113 to be contaminated by the underfill, resulting in the subsequent inability to connect optical fiber elements, thereby resulting in a decrease in product yield.

Therefore, how to overcome the above-mentioned drawbacks of the prior art has become an urgent issue to be solved.

### SUMMARY

In view of the various deficiencies of the prior art, the present disclosure provides an optical package module, which comprises: a support structure; a photonic chip disposed on the support structure and including a chip body and a plurality of stoppers formed on opposite sides of the chip body; and a filling layer filled between the support structure and the photonic chip.

The present disclosure further provides a photonic chip, which comprises: a chip body; and a plurality of stoppers formed on opposite sides of the chip body.

The present disclosure further provides a method for manufacturing a photonic chip, which comprises: providing a semiconductor substrate, which is defined with a plurality of active areas arranged in an array and a connection area between the plurality of active areas, wherein each of the active areas is formed with a chip body; forming a plurality of stoppers on opposite sides of the chip body; and performing a singulation along a periphery of each chip body to obtain a plurality of photonic chips.

In the aforementioned optical package module, the photonic chip and the manufacturing method thereof, the photonic chip is mounted onto the support structure via a plurality of conductive bumps. The filling layer covers the plurality of conductive bumps. The support structure is a substrate, an intermediate board, a circuit structure or a package unit.

In the aforementioned optical package module, the photonic chip and the manufacturing method thereof, each of the opposite sides of the chip body is formed with a trench region, and the plurality of stoppers are located in the trench region. A front side of the chip body is formed with a waveguide region. The photonic chip overhangs and protrudes an edge of the support structure from one side having the waveguide region.

In the aforementioned optical package module, the photonic chip and the manufacturing method thereof, the plurality of stoppers are formed in the connection area of the semiconductor substrate by a patterning process and correspond to the opposite sides of the chip body.

As can be seen from the above, in the optical package module and the photonic chip and the manufacturing method thereof of the present disclosure, the plurality of stoppers are formed on the opposite sides (trench regions) of the photonic chip to facilitate the subsequent placement of the photonic chip on the support structure. When the filling layer is disposed between the photonic chip and the support structure, the plurality of stoppers are used to lengthen the distance from the filling layer to the waveguide region (allowing the filling layer to take a detour), shorten the overflow distance of the filling layer, and prevent the filling layer from overflowing into the waveguide region of the photonic chip and causing contamination of the waveguide region, thereby improving a product yield.

### BRIEF DESCRIPTION OF THE DRAWINGS

FIG. 1A is a schematic cross-sectional view of a conventional co-package optic device.

FIG. 1B is a partial bottom view of a conventional co-package optic device.

FIG. 2A to FIG. 2C are schematic views illustrating a manufacturing method of a photonic chip according to the present disclosure.

FIG. 3A and FIG. 3B are schematic plan and cross-sectional views of an optical package module according to the present disclosure.

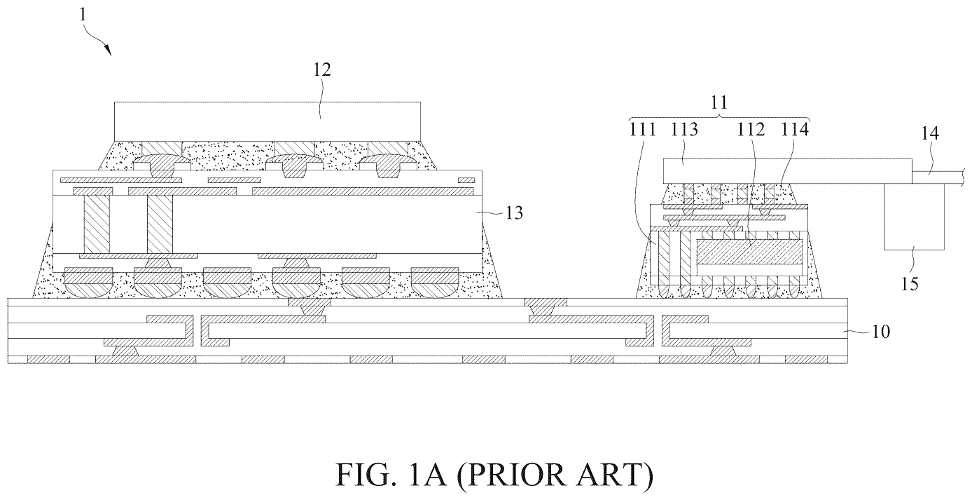

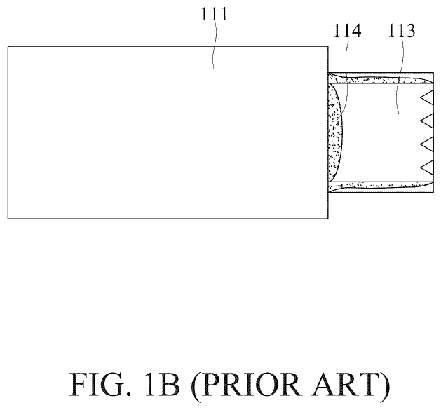

### DETAILED DESCRIPTION

The following describes the embodiments of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “upper,” “on,” “first,” “second,” “third,” “a,” “one,” and the like are merely used for clear explanation rather than limiting the practicable scope of the present disclosure, and thus, alterations or adjustments of the relative relationships thereof without essentially altering the technical contents should still be considered in the practicable scope of the present disclosure.

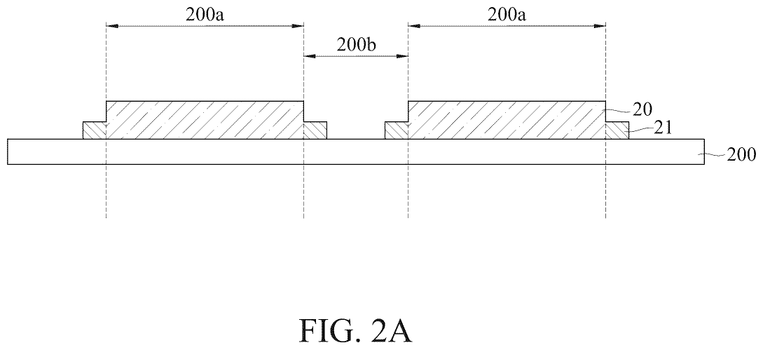

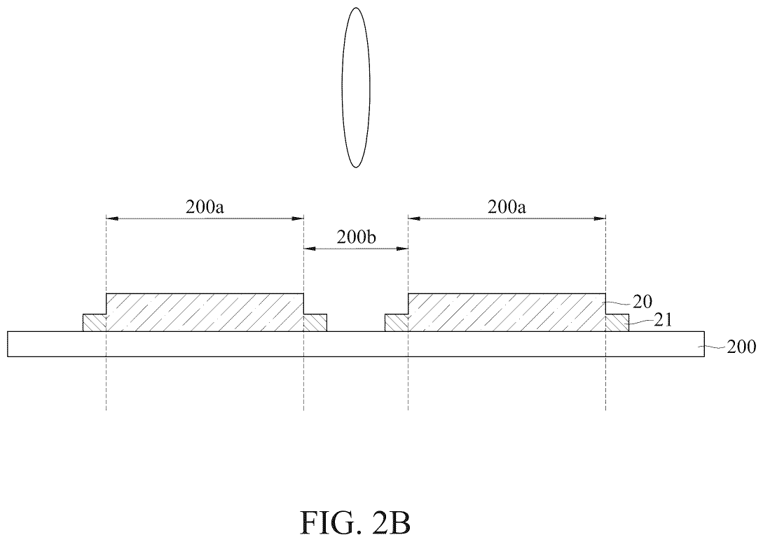

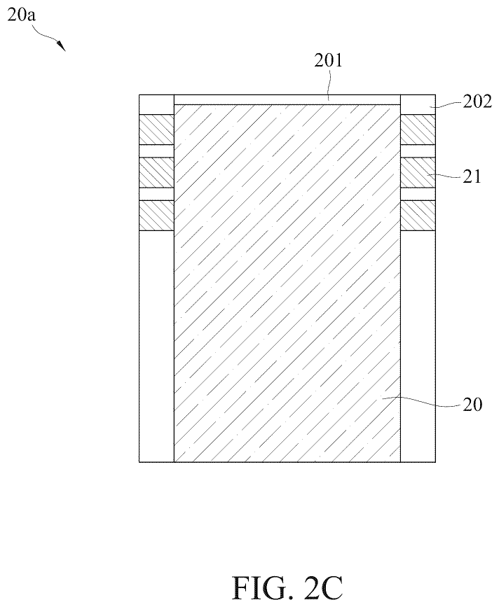

Please refer to FIG. 2A to FIG. 2C, which are schematic views illustrating a manufacturing method of a photonic chip according to the present disclosure.

As shown in FIG. 2A, a semiconductor substrate 200 (such as a wafer, a silicon substrate or a glass substrate) is provided, which defines a plurality of active areas 200a arranged in an array and a connection area 200b located between the plurality of active areas, and a chip body 20 is formed in each of the active areas 200a.

Then, a plurality of stoppers 21 are formed on opposite sides (left side and right side) of the chip body 20. In one embodiment, the plurality of stoppers 21 are, for example, polyimide (PI) or photoresist, and are formed in the connection area 200b of the semiconductor substrate 200 and corresponding to two sides of the chip body 20 by a patterning process.

As shown in FIG. 2B, a singulation is then performed along a periphery of each chip body 20 (i.e., the connection area 200b) to obtain a plurality of photonic chips 20a (as shown in the plan view of FIG. 2C).

The photonic chip 20a includes a chip body 20 and a plurality of stoppers 21 formed on opposite sides of the chip body 20.

In addition, a front side of the chip body 20 is formed with a waveguide region 201, the opposite sides of the chip body 20 is formed with a trench region 202, and the plurality of stoppers 21 are located in the trench region 202.

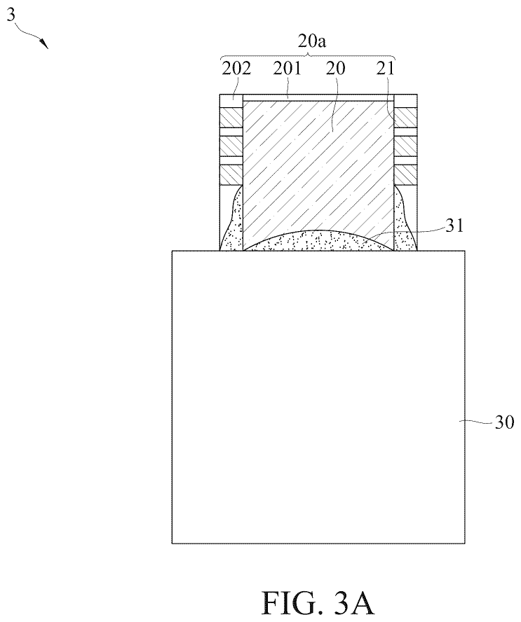

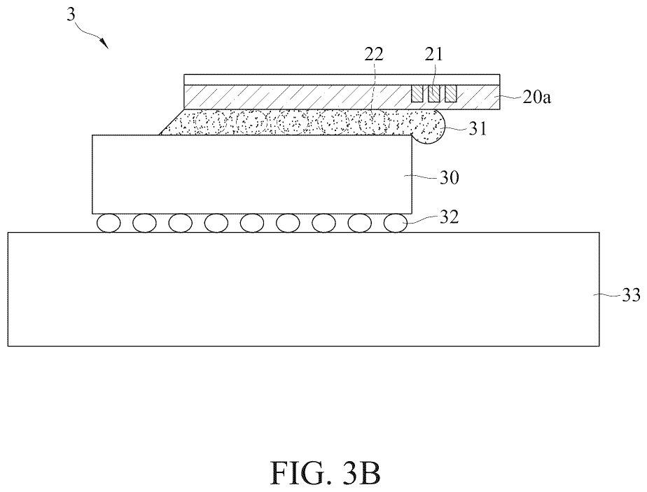

Please refer to FIG. 3A and FIG. 3B, which are schematic plan and cross-sectional views of an optical package module according to the present disclosure.

As shown in FIG. 3A, one surface of the photonic chip 20a is subsequently mounted onto a support structure 30 via a plurality of conductive bumps 22 and electrically connected to the support structure 30. The photonic chip 20a overhangs and protrudes an edge of the support structure 30 from one side having the waveguide region 201. The support structure 30 is, for example, a substrate, an intermediate board, a circuit structure, or a package unit.

Next, a filling layer 31 is formed between the photonic chip 20a and the support structure 30, and the filling layer 31 covers the plurality of conductive bumps 22 to obtain an optical package module 3.

The optical package module 3 includes a support structure 30, a photonic chip 20a disposed on the support structure 30, and the filling layer 31 filled between the support structure 30 and the photonic chip 20a.

The photonic chip 20a includes a chip body 20 and a plurality of stoppers 21 formed on opposite sides of the chip body 20. A contamination of the waveguide region 201 caused by an overflow of the filling layer 31 to the waveguide region 201 of the photonic chip 20a can be avoided.

As shown in FIG. 3B, the support structure 30 can be further mounted onto a circuit board 33 via a plurality of conductive elements 32 and electrically connected to the circuit board 33.

To sum up, in the optical package module and the photonic chip and the manufacturing method of the present disclosure, a plurality of stoppers are formed on the opposite sides (trench regions) of the photonic chip to facilitate the subsequent placement of the photonic chip on the support structure. When the filling layer is disposed between the photonic chip and the support structure, the plurality of stoppers are used to lengthen the distance from the filling layer to the waveguide region (allowing the filling layer to take a detour), shorten the overflow distance of the filling layer, and prevent the filling layer from overflowing into the waveguide region of the photonic chip and causing contamination of the waveguide region, thereby improving a product yield.

In addition, the optical package module and the photonic chip thereof have high technical feasibility and can be manufactured using existing semiconductor packaging equipment. There is no need to develop special processes or purchase special equipment, thereby can reduce product production costs.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. An optical package module, comprising:
a support structure;
a photonic chip disposed on the support structure and including a chip body and a plurality of stoppers formed on opposite sides of the chip body; and
a filling layer filled between the support structure and the photonic chip.

2. The optical package module of claim 1, wherein the photonic chip is mounted onto the support structure via a plurality of conductive bumps.

3. The optical package module of claim 2, wherein the filling layer covers the plurality of conductive bumps.

4. The optical package module of claim 1, wherein the support structure is a substrate, an intermediate board, a circuit structure or a package unit.

5. The optical package module of claim 1, wherein each of the opposite sides of the chip body is formed with a trench region for the plurality of stoppers to be located in the trench region.

6. The optical package module of claim 1, wherein a front side of the chip body is formed with a waveguide region.

7. The optical package module of claim 6, wherein the photonic chip overhangs and protrudes an edge of the support structure from one side having the waveguide region.

8. A photonic chip, comprising:
a chip body; and
a plurality of stoppers formed on opposite sides of the chip body.

9. The photonic chip of claim 8, wherein each of the opposite sides of the chip body is formed with a trench region, and the plurality of stoppers are located in the trench region.

10. The photonic chip of claim 8, wherein a front side of the chip body is formed with a waveguide region.

11. A method for manufacturing a photonic chip, comprising:
providing a semiconductor substrate defined with a plurality of active areas arranged in an array and a connection area between the plurality of active areas, each of the active areas formed with a chip body;
forming a plurality of stoppers on opposite sides of the chip body; and
performing a singulation along a periphery of each chip body to obtain a plurality of photonic chips.

12. The method of claim 11, wherein the plurality of stoppers are formed in the connection area of the semiconductor substrate by a patterning process and correspond to the opposite sides of the chip body.

13. The method of claim 11, wherein each of the opposite sides of the chip body is formed with a trench region, and the plurality of stoppers are located in the trench region.

14. The method of claim 11, wherein a front side of the chip body is formed with a waveguide region.
